(19) United States
(12) Patent Application Publication
(10) Pub. No.: US 2005/0135446 A1
(43) Pub. Date: Jun. 23, 2005

(54) Electrically driven organic optical resonator

(75) Inventor: Francisco J. Duarte, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/017,309

(22) Filed: Dec. 17, 2004

Related U.S. Application Data
(60) Provisional application No. 60/530,302, filed on Dec. 17, 2003.

(51) Int. Cl. H01S 3/14

(52) U.S. Cl. 372/39; 372/92; 372/19

(57) ABSTRACT

An electrically driven thin-film organic optical resonator. The thin-film organic optical resonator comprises a substrate, a back mirror provided on the substrate, at least one active region deposited on the back mirror, an external mirror, and electrical excitation means. At least one active region includes organic gain material. The external mirror is provided at a predetermined distance from at least one active region such that the back mirror combined with the external mirror forms an optical resonator. The electrical excitation means is provided for exciting the organic gain material to produce coherent emission with a wavelength and at least one transverse electromagnetic mode in the optical resonator.

### CROSS REFERENCE TO RELATED APPLICATIONS

Priority is claimed from commonly assigned provisional patent application U.S. Ser. No. 60/530,302 entitled “OPTICAL RESONATOR ARCHITECTURES FOR ELECTRICALLY EXCITED ORGANIC LASERS”, filed on Dec. 17, 2003 in the name of Duarte, incorporated herein by reference.

### FIELD OF THE INVENTION

This invention relates in general to the field of optics, and in particular to visible optical coherent sources using organic gain media. More specifically, the present invention relates to an optical resonator architecture for electrically excited organic gain media.

### BACKGROUND OF THE INVENTION

There are many potential applications for visible lasers, such as display, optical storage reading/writing, laser printing, and short-haul telecommunications employing plastic optical fibers. Refer to US Patent Application No. 2004/0076204 (Kruschwitz), commonly assigned and incorporated herein by reference.

In an effort to produce visible wavelength lasers, some individuals have abandoned inorganic-based systems and focused on organic-based laser systems, since organic-based gain materials can enjoy a number of advantages over inorganic-based gain materials in the visible spectrum. Traditional dye lasers, for example offer a very wide range of wavelengths. However, liquid dye lasers are complex devices which require special engineering to facilitate and control the flow of dye.

Other organic-based gain materials have the beneficial properties of low unpumped scattering/absorption losses and high quantum efficiencies. In comparison to inorganic laser systems, organic lasers are relatively inexpensive to manufacture, and are inherently tunable. Organic solid-state laser gain material has been mainly dye-doped polymers and dye-doped polymer nanoparticle media. In the literature, this gain media are deployed in resonant cavity structures, such as dispersive oscillators and distributed feedback lasers.

A problem with all of these structures is that in order to achieve coherent emission it was necessary to excite the cavities by optical pumping using a laser source. Optically-pumped organic lasers are well-known, and widely applied, sources of tunable laser radiation. (See F. J. Duarte and L. W. Hillman (eds.), Dye Laser Principles (Academic, New York, 1990).)

It is much preferred to electrically pump the laser cavities since this generally results in more compact and easier to modulate structures. Recently, the attention has been focused on the possibility of demonstrating electrically excited organic lasers. (See G. Kranzelbinder and G. Leising, Rep. Prog. Phys. 63, 729-762 (2000).) There exists a need for tunability in an organic-based laser structure capable of being electrically excited.

The present invention is directed to an electrically organic device delivering coherent emission. More particularly, the present invention is directed to resonator and oscillator optical cavity architectures designed to achieve spatially and spectrally coherent tunable radiation, using known electrically-excited organic emission media. These oscillator architectures are designed to comprise an extremely low power source yielding a Gaussian spatial beam distribution and highly coherent radiation in the spectral domain.

### SUMMARY OF THE INVENTION

An object of the present invention is to provide an electrically driven organic optical resonator.

Another object of the present invention is to provide such an electrically driven organic optical resonator which provides tunability in an organic-based optical resonator, and more particularly, narrow linewidth tunability.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided a thin-film organic optical resonator. The thin-film organic optical resonator comprises a substrate, a back mirror provided on the substrate, at least one active region deposited on the back mirror, an external mirror, and electrical excitation means. The at least one active region includes organic gain material. The external mirror is provided at a predetermined distance from the at least one active region such that the back mirror combined with the external mirror forms a laser resonator. The electrical excitation means is provided for exciting the organic gain material to produce coherent emission with a wavelength and at least one transverse electromagnetic mode in the optical resonator.

According to another aspect of the invention, there is provided a thin-film organic optical resonator comprising a transparent substrate, a partially transmitting back mirror provided on the substrate, at least one active region deposited on the partially transmitting back mirror, an external mirror, and electrical excitation means. The external mirror is provided at a predetermined distance from the at least one active region such that the partially transmitting back mirror combined with the external mirror forms an optical resonator. The electrical excitation means is provided for exciting the organic gain material to produce a coherent emission with a wavelength and at least one transverse electro-magnetic mode in the optical resonator.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 is a schematic view of a thin-film organic optical resonator in accordance with the present invention.

FIG. 2 is a cross-section of the gain device in accordance with the present invention.

FIG. 3 shows a transmission grating optical resonator configuration suitable for use with the present invention.

FIGS. 4-6 show a reflection grating optical resonator configurations suitable for use with the present invention.

FIG. 7 shows is a cross-section of an alternate gain device in accordance with the present invention.

### DETAILED DESCRIPTION OF THE INVENTION

The following is a detailed description of the preferred embodiments of the invention, reference being made to the drawings in which the same reference numerals identify the same elements of structure in each of the several figures.

The present invention uses organic-based gain materials in an external cavity.

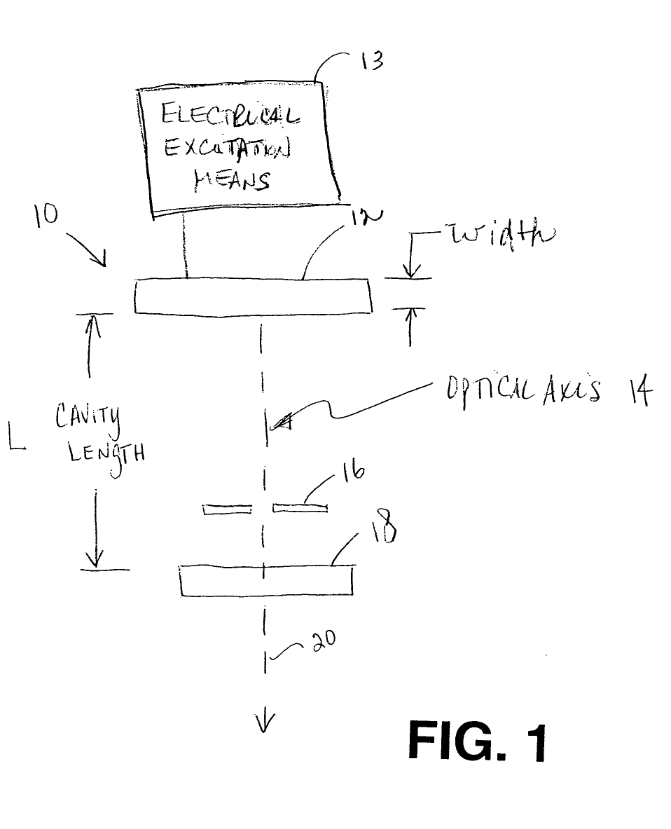

Referring to FIG. 1, a schematic of the thin-film organic optical resonator 10 is shown. The thin-film organic optical resonator 10 comprises a gain device 12. Gain device 12 is electrically excited/driven (by electrical excitation means 13) to emit coherent emission directed along an optical axis 14 through an aperture 16 onto an external mirror or partially reflective mirror 18. External mirror 18 provides optical feedback to cause stimulated emission, and therefore all the required elements of a coherent source are provided. Emitted coherent radiation 20 is produced, which comprises the portion of the coherent emission that passes through external mirror 18.

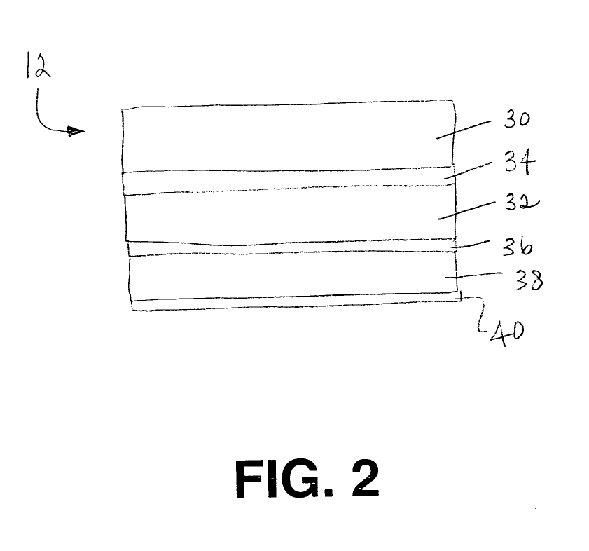

FIG. 2 shows a cross-section of gain device 12 in accordance with the present invention. Gain device 12 is comprised of a substrate 30 with an organic gain medium film structure 32 (i.e., the gain medium) disposed on one side of substrate 30. Organic gain medium film structure 32 comprises at least one active region having an organic gain material. Intermediate substrate 30 and organic gain medium film structure 32 is a back mirror 34 comprised of a reflective material. Deposited one a surface of organic gain medium film structure 32 is an anti-reflective material 36. Gain device 12 is further comprised of an optically transparent material 38 (such as glass or the like) and anti-reflective material 40.

Organic laser gain medium structures are known to those skilled in the art, and can be, for example, the organic laser film structure (i.e., element 32) disclosed in US Patent Application No. 2004/0076204 (Kruschwitz), commonly assigned and incorporated herein by reference.

Electrical excitation means 13 excites gain device 12 to produce broadband light emission centered at a wavelength typical of a laser dye (of organic laser film structure 32) used to dope organic gain medium film structure 32. That is, the electrical excitation causes the emission of light with a central wavelength and intensity resulting in organic gain medium film structure 32 emitting coherent emission of wavelength λ. The wavelength λ is within a range of desired wavelengths that may represent a tuning range. External mirror 18 provides optical feedback to cause stimulated emission, and therefore all the required elements of a coherent source are provided. Emitted laser beam 20 is produced, which comprises the portion of the coherent emission that passes through the external mirror 18.

Returning now to FIG. 1, gain device 12 and external mirror 18 define a optical resonator, or external cavity. More particularly, external mirror 18 is provided at a predetermined distance from organic gain medium film structure 32 such that bottom mirror 34 combined with external mirror 18 forms an optical resonator. Gain device 12 and external mirror 18 are aligned relative to an optical axis and are spaced apart by a distance defining a cavity length L. Cavity length L is actually an optical thickness, i.e. the sum of the products of the refractive indices and thicknesses of each material within the resonator. In all practical cases, though, this will be dominated by the distance in air between gain device 12 and external mirror 18, and hence closely resembles the physical length of the resonator. The lowest shortest resonator length L would be equal to an active region thickness. Below this, an external resonator is meaningless. In order to generate a reasonable mode size, the resonator length L would be greater than 10 mm.

Electrical excitation means 13 are known to those skilled in the art. A excitation means 13 suitable for the present invention includes, for example, a high power pulsed generator yielding up to about 200 Volts per pulse with rise times in the nanosecond regime.

It is noted that the electrically excited organic media, considered as the source of broadband radiation, can be a traditional organic emitting diode structure, for example, such as disclosed by Tang et al. in: C. W. Tang et al., J. Appl. Phys. 65, 3610-3616 (1989).

More particular are the tandem devices disclosed by Liao et al. in: L. S. Liao, K. P. Klubek, and C. L. Tang, Appl. Phys. Lett. 84, 167-169 (2004). Of particular interest is that, in these devices, the p-n junction is doped with a known laser dye such as Coumarin 540 or Coumarin 545T. Coumarin tetramethyl dyes have been well known laser dyes (refer to: C. H. Chen, J. L. Fox, F. J. Duarte, and J. J. Ehrlich, Appl. Opt. 27, 443-445 (1988).).

This media is comprised of an antireflection coating at the output interface, for example, MgF₂. This corresponds with anti-reflection material 36 or 40 of FIG. 2. This antireflection coating preferably provides a reflectivity of less than about 1%, and more particularly, this reflectivity should be about 0.3%.

It is preferred that gain device 12 is a dye-doped organic semiconductor gain media. A pulsed excitation of the dye-doped organic semiconductor gain media 12 is preferred. These pulses can approach about 50 to about 200 V in amplitude with rise times in the nanosecond domain. Under those conditions, the current through the semiconductor exceeds 110 mA and the current density is greater than 1.3 A/cm.². For pulses lasting about 1 ms, this represents an energy density of about 0.13 J/cm². This energy density greatly exceeds the laser thresholds in optically pumped organic light emitting diodes reported by Riechel et al. and Holzer et al., which are in the range of 0.00000882-0.000016 J/cm². (See: S. Riechel, U. Lemmer, J. Feldmann, S. Berleb, A. G Mückl, W. Brütting, Agombert and W. Witter, Opt. Lett. 26,593-595 (2001). See also: W. Holzer et al. , Appl. Phys. B 74, 333-342 (2002).)

Preferably, the electrical excitation means excites the organic gain material using a pulse excitation having a repetition rate of about 1 to about 100 Hz.

With regard to resonator/oscillator architectures, it is well known in laser physics that the transverse mode structure of the emission depends on the geometry of the cavity. (See: (1) 12. F. J. Duarte (Ed.), High Power Dye Lasers (Springer, Berlin, 1991); (2) F. J. Duarte (Ed.), Handbook of Tunable Lasers (Academic, New York, 1995); (3) F. J. Duarte, Tunable Laser Optics (Elsevier Academic, New York, 2003); and (4) A. E. Siegman, Lasers (University Science, Mill Valley, 1986).)

This is the result of well established principles of diffraction theory. More particularly, a coherent source comprised by a long cavity length (L) with a narrow intracavity aperture can yield a clean near-Gaussian beam profile. An example is a visible laser with a cavity length of 30 cm and an intracavity aperture, defining the diameter of the beam (2 w), of 0.5 mm.

According to the same principle, if the cavity is short and the beam wide, then the profile of this beam will contain a multitude of transverse modes. Thus, it can be shown that the spatial coherence of the beam depends roughly on the ratio:
N=w²/Lλ
wherein N is the Fresnel number, w is the beam width (D=2 w), L is the cavity length, and λ is the wavelength.

A ratio near 1 yields a near single-transverse mode, or a spatially coherent beam. In at least one known reference (see F. J. Duarte, Tunable Laser Optics (Elsevier Academic, New York, 2003)), it is explained that a first step in designing a narrow-linewidth oscillator is to provide the geometrical conditions to make N approximately equal to 1 or lower.

Once the optical design is compatible with the diffraction principle outlined above, then dispersive elements are introduced into the cavity to produce narrow-linewidth emission which is emission coherent in the spectral domain. This is explained in detail in known references. (See (1) F. J. Duarte, Tunable Laser Optics (Elsevier Academic, New York, 2003); and (2) F. J. Duarte and L. W. Hillman (eds.), Dye Laser Principles (Academic, New York, 1990).)

Various cavity architectures and cavity dimensions can be employed to yield spatially and spectrally coherent emission. For example, a transmission grating or a reflection grating can be employed.

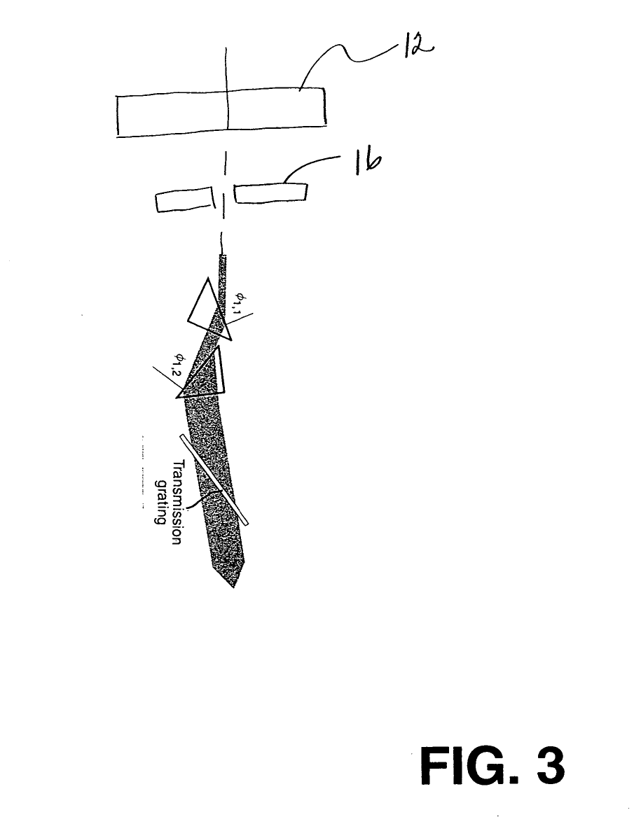

FIG. 3 shows an example of a transmission grating optical configuration. A transmission grating in Littrow configuration can be employed. The grating can be a transmission holographic grating with a groove density of about 1200-3200 lines/mm, with 1200-1300 lines per mm being of particular interest.

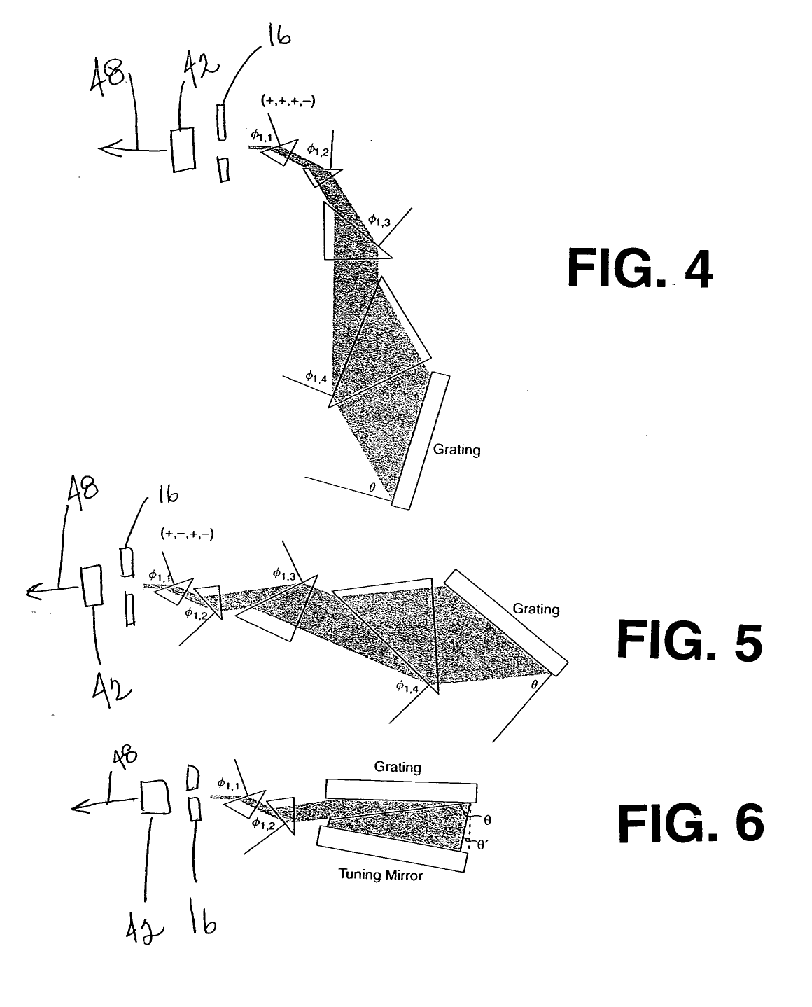

FIGS. 4-6 show an example of a reflection grating optical configuration. A reflection grating in Littrow configuration can be employed. The grating can be a reflection grating with a groove density of about 1200-3200 lines/mm.

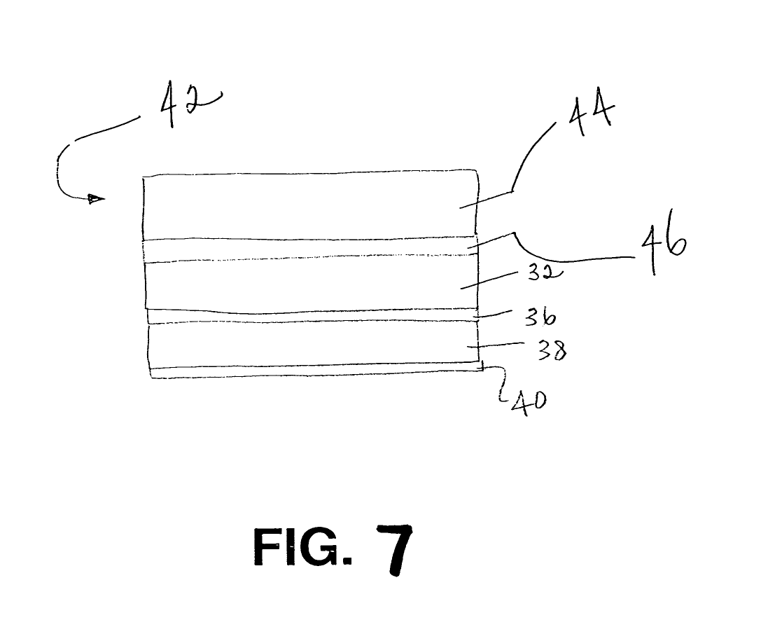

With regard to FIGS. 4-6, an alternative gain device 42, shown in FIG. 7, can be employed. As shown in FIG. 7, gain device 42 has a transparent substrate 44 and a partially transmitting back mirror 46, which is preferably 80% reflecting. With this configuration, an emission beam 48 is coupled through partially transmitting back mirror 46.

The multiple-prism grating assemblies shown in FIGS. 3-6 allow the emission to be narrow linewidth and tunable.

The dispersive optics can be a single or a plurality of prisms, as known to those skilled in the art. The dispersive assembly is optional, depending on the desired emission linewidth Δv.

A multiple-prism grating assembly can also be of a near-grazing incidence class, as known to those skilled in the art.

The beam diameter (i.e., size of aperture) is adjustable to achieve single transverse mode emission beam quality.

The present invention can employ known electrically driven organic light emitting structures, with an antireflection output coating, in conjunction with resonator cavities designed to yield spatially and spectrally highly coherent radiation to produce a very low power organic coherent source. More particularly, the quality of the emission does not depend on its high power but on its spatial and spectral coherence.

In addition, the light emitting organic device is operated in the pulsed regime and is preferably excited with pulses with rise times in the 10 ns regime or less. The pulses can last 10s or 100s of ns or approach 100s of μm. These excitation parameters are derived from the dye laser literature since some or the active media can be of the dye molecular class.

The antireflection coating (i.e., element 36 and 40 of FIG. 2), for example MgF₂, with a reflectivity in the range of about 0.3% to about 1.0% provides for the control of the emission with the dispersive elements of the cavity.

One task in confirming coherent emission is in the measurements of spectral coherence. Spatial emission in the form of a near-Gaussian distribution has been measured using electronic imaging means and spectral coherence has been determined using interferometry.

Amplification of the coherent output to higher powers can be accomplished using well-known laser amplification methods, such as described in F. J. Duarte, Tunable Laser Optics (Elsevier Academic, New York, 2003).

All documents, patents, journal articles and other materials cited in the present application are hereby incorporated by reference.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A thin-film organic optical resonator, comprising:
a substrate;
a back mirror provided on the substrate;
at least one active region deposited on the back mirror, wherein the at least one active region includes organic gain material;
an external mirror provided at a predetermined distance from the at least one active region such that the back mirror combined with the external mirror forms a optical resonator; and
electrical excitation means for exciting the organic gain material to produce coherent emission with a wavelength and at least one transverse electromagnetic mode in the optical resonator.

2. The thin-film organic optical resonator of claim 1, further comprising an aperture with a selectable sized hole for controlling the at least one transverse electromagnetic mode.

3. The thin-film organic optical resonator of claim 2, wherein the selectable sized hole is a circle.

4. The thin-film organic optical resonator of claim 1, wherein the electrical excitation means provides the excitation of the organic gain material to yield the emission of the at least one transverse electromagnetic mode such that an excitation distribution overlaps an intensity profile of the at least one transverse electromagnetic mode.

5. The thin-film organic optical resonator of claim 1, further comprising an antireflection region deposited on the at least one active region.

6. The thin-film organic optical resonator of claim 5, wherein the antireflection region provides a reflectivity of less than about 1%.

7. The thin-film organic optical resonator of claim 1, wherein the electrical excitation means excites the organic gain material using a pulse up to about 200 V amplitude.

8. The thin-film organic optical resonator of claim 1, wherein the electrical excitation means excites the organic gain material using a pulse excitation having a rise time of about 1 to about 10 nanoseconds.

9. The thin-film organic optical resonator of claim 1, wherein the electrical excitation means excites the organic gain material using a pulse excitation having a repetition rate of about 1 to about 100 Hz.

10. The thin-film organic optical resonator of claim 1, wherein the electrical excitation means excites the organic gain material using a pulse excitation having duration from about 1 microsecond to about 10 nanoseconds.

11. The thin-film organic optical resonator of claim 1, further comprising multiple-prism grating assemblies adapted to generate narrow linewidth tunable emission.

12. A thin-film organic optical resonator, comprising:
a transparent substrate;
a partially transmitting back mirror provided on the substrate;
at least one active region deposited on the partially transmitting back mirror, wherein the at least one active region includes organic gain material;
an external mirror provided at a predetermined distance from the at least one active region such that the partially transmitting back mirror combined with the external mirror forms an optical resonator; and
electrical excitation means for exciting the organic gain material to produce coherent emission with a wavelength and at least one transverse electro-magnetic mode in the optical resonator.

13. The thin-film organic optical resonator of claim 12, wherein the coherent emission output is coupled through the partially transmitting back mirror.
